(19) United States
(12) Patent Application Publication
(10) Pub. No.: US 2018/0095435 A1
(43) Pub. Date: Apr. 5, 2018

(54) SYSTEMS AND METHODS FOR RAPID INDUSTRIAL NETWORK TROUBLESHOOTING FOR AUTOMATION SYSTEMS

(71) Applicant: Siemens Industry Inc., Alpharetta, GA (US)

(72) Inventors: Kyle R. McMillan, Fall Branch, TN (US); Charles A. Searles, Knoxville, TN (US)

(21) Appl. No.: 15/282,054

(22) Filed: Sep. 30, 2016

(51) Int. Cl. G05B 19/048; G05B 11/01; G05B 19/12

(52) U.S. Cl. CPC G05B 19/048; H04L 67/125; G05B 19/124; G05B 11/011

(57) ABSTRACT

A diagnostics system for rapid industrial network troubleshooting for an automation system includes a user interface device with a memory device storing a computer program with executable instructions; an automation component with an identification tag; and a communication network interfacing with the user interface device and the automation component, and adapted to transmit data. The computer program of the user interface device includes instructions to establish communication with the automation component based on data of the identification tag via the communication network, and instructions to retrieve diagnostics data of the automation component via the communication network after establishing communication with the automation component. Further, a diagnostics method and a computer program product for rapid industrial network troubleshooting for an automation system are provided.

### BACKGROUND

### 1. Field

Aspects of the present invention generally relate to industrial and other automation systems, and more particularly to systems, methods and computer readable media for rapid industrial network troubleshooting for an automation system, in particular a distributed automation system.

### 2. Description of the Related Art

Industrial automation systems are used in different industrial fields in order to automatically perform a plurality of tasks, for example in a manufacturing process or an assembly line of production facility. Distributed industrial automation systems comprise a plurality of interconnected components, such as for example sensors, actuators and control devices. The components of an automation system are herein referred to as automation components. The control devices can be for example programmable logic controllers (PLCs) for controlling and monitoring process parameters. For example, within an industrial automation system, one or more sensors may be communicatively coupled to one or more PLC(s) via one or more input/output (I/O) modules, e.g., a communication module. Via the I/O modules, the PLC(s) may control one or more devices such as, for example, a rheostat, a switch, a sequencer, a servo drive, a motor, and/or a valve etc. Furthermore, operator terminals provide interfaces to the automation system for monitoring, controlling and displaying information to an operator or end user. Operator terminals are also known as Human-Machine-Interface (HMI) devices which allow effective operation and control of the components and devices of the automation system from the human end, i.e. the operator or end user, while the components/devices of the automation system feed information back to the operator/end user.

The automation components (for example sensors, actuators and control devices) of an automation system are further interconnected via an industrial network for communication purposes. Industrial networks used in an industrial environment include protocols that provide determinism and real-time control. For example, industrial Ethernet (IE) is the use of Ethernet in an industrial environment with protocols that provide determinism and real-time control. Protocols for Industrial Ethernet include PROFINET, EtherCAT, EtherNet/IP, POWERLINK, etc.

Due to their complexity, automation systems need to be monitored in order to detect failures or malfunctions in the operation of the system. Known solutions consist of centralized supervisory applications and HMI panels (fixed or mobile) running proprietary applications for diagnostics and troubleshooting. But many automation components of a distributed automation system do not have built-in HMIs or operator terminals to allow end users to diagnose faults locally. If the automation components do have built-in operator terminals, these automation components may be limited in the information they can provide. For example, a blinking red light on a PLC may indicate a fault, but diagnosing the fault may require additional information, for example consulting a PLC manual or a centralized supervisory application. Thus, a need exists for diagnostics systems and methods for rapid, flexible and portable industrial network troubleshooting.

### SUMMARY

Briefly described, aspects of the present invention relate to a system, a method and a computer readable medium for rapid industrial network troubleshooting for an industrial automation system including an industrial network comprising an Industrial Ethernet (IE) protocol.

A first aspect of the present invention provides a diagnostics system for rapid industrial network troubleshooting for an automation system comprising a user interface device comprising a memory device storing a computer program with executable instructions; an automation component comprising an identification tag; and a communication network interfacing with the user interface device and the automation component, and adapted to transmit data, wherein the computer program of the user interface device comprises instructions to establish communication with the automation component based on data of the identification tag via the communication network, and wherein the computer program of the user interface device comprises instructions to retrieve diagnostics data of the automation component via the communication network after establishing communication with the automation component.

A second aspect of the present invention provides a computer program product embodied in a non-transitory computer-readable medium comprising instructions to read an identification tag carried by an automation component, instructions to establish communication to the automation component based on data of the identification tag via a communication network; and instructions to retrieve diagnostics data of the automation component via the communication network after establishing communication with the automation component.

A third aspect of the present invention provides a diagnostics method for rapid industrial network troubleshooting for an automation system comprising reading, by a user interface device, an identification tag carried by an automation component, establishing communication by the interface device to the automation component based on data of the identification tag via a communication network; and retrieving diagnostics data of the automation component by the user interface device via the communication network after establishing communication with the automation component.

### BRIEF DESCRIPTION OF THE DRAWINGS

FIG. 1 illustrates a first schematic diagram of a diagnostics system for rapid industrial network troubleshooting for an industrial automation system in accordance with an exemplary embodiment of the present invention.

FIG. 2 illustrates a second schematic diagram of a diagnostics system for rapid industrial network troubleshooting for an industrial automation system in accordance with an exemplary embodiment of the present invention.

FIG. 3 illustrates a third schematic diagram of a diagnostics system for rapid industrial network troubleshooting for an industrial automation system in accordance with an exemplary embodiment of the present invention.

FIG. 4 illustrates a graphical representation of a screenshot of a user interface device in accordance with an exemplary embodiment of the present invention.

FIG. 5 illustrates a flow chart of a diagnostics method for rapid industrial network troubleshooting for an industrial automation system in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of industrial and other automation systems, and more particularly in the context of diagnostics systems, methods and computer readable media for rapid industrial network troubleshooting for an automation system. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

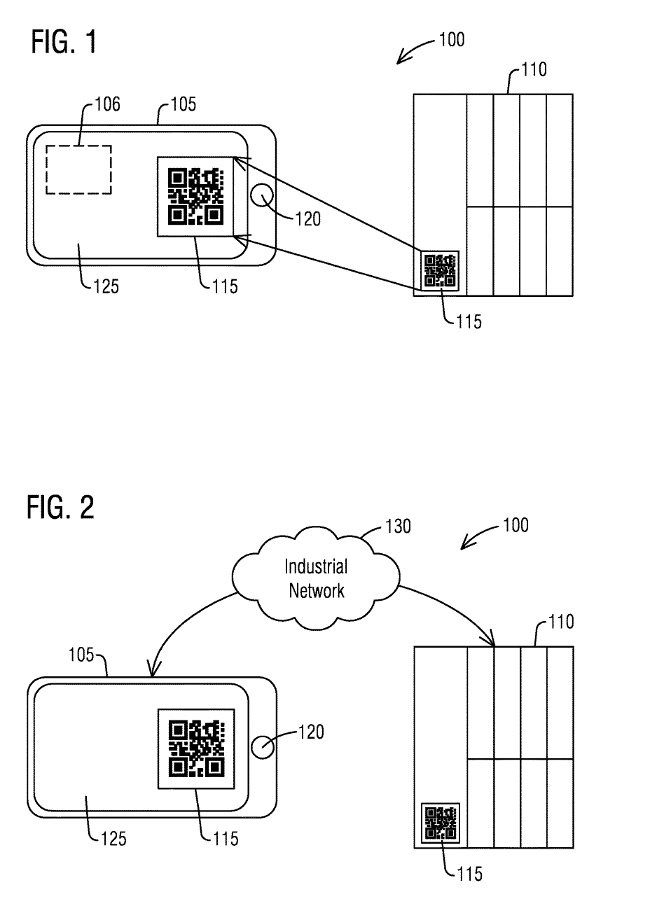

FIG. 1 illustrates a first schematic diagram of a diagnostics system 100 for rapid industrial network troubleshooting, herein also shortly referred to as diagnostics system 100, for an industrial automation system in accordance with an exemplary embodiment of the present invention. The diagnostics system 100 comprises a user interface device 105 and an automation component 110.

The user interface device 105 is a mobile device and/or hand-held device comprising a memory device 106 storing a computer program with executable instructions, such as program modules, being executed by a computer system. Generally, program modules include routines, programs, programming, objects, components, data, data structures, and the like that perform particular tasks or implement particular abstract data types. The user interface device 105 can be for example a touch screen device, a tablet, smart phone, personal computer, laptop computer or the like, with storage and wireless capabilities. Furthermore, the user interface device 105 comprises an imaging device 120, such as for example a digital camera, for capturing images and data, and a display or screen 125 for displaying data, images, information etc. The memory device 106 of the user interface device 105 is configured as non-volatile, removable, and/or non-removable medium implemented in many methods or technologies for storage of information such as computer-readable instructions, data, data structures, program modules, programs, programming, or routines.

The automation component 110 is a component of an industrial or other automation system, wherein the automation component 110 can comprise hardware and/or software and can be an interconnected component of an automation system. For example, the automation component 110 can be a sensor, an actuator, a valve, a drive, a field device etc. The automation component 110 can also be a control device such as a programmable logic controller (PLC) or other computing device, such as for example a terminal computer or operator panel.

The automation component 110 comprises an identification tag 115. The identification tag 115 can be a physical element which can be attached to the automation component 110. For example, the identification tag 115 can be a sticker or similar type of tag or label made of paper and/or plastics which can be attached to an outside, for example housing or enclosure, of the automation component 110. According to a further embodiment, the identification tag 115 may be a permanent part of the automation component 110. For example, the identification tag 115 may be printed directly onto the automation component 110. The identification tag 115 can be generated either by a provider of the automation component 115 or by customers of the automation component 115. Alternatively, the identification tag 115 may be configured as software tag and displayed on a screen or display of the automation component 110 in case the automation component 110 comprises a screen or display. The identification tag 115 comprises data and/or information which uniquely describe and identify the automation component 110.

The identification tag 115 can comprise a Quick Response (QR) code, a barcode, or like machine-readable representation of data. A barcode is a machine-readable optical label that contains information about the item to which it is attached. A QR code consists of black modules (square dots) arranged in a square grid on a white background, which can be read by an imaging device (such as a camera) and processed using corresponding software.

In an exemplary embodiment as illustrated in FIG. 1, the automation component 110 comprises a QR code in form of a label or sticker attached to an enclosure of the automation component 110. The QR code is attached to the automation component 110 so that the QR code is easily accessible and readable.

FIG. 1 further schematically illustrates that the identification tag 115 of the automation component 110 is captured by the user interface device 105. For example, the user interface device 105 uses the imaging device 120, which can be for example a digital camera, to capture the identification tag 115 (QR code). In other words, the user interface device 105 reads a QR code fixed to the automation component 110 via a camera-based augmented reality interface.

FIG. 2 illustrates a second schematic diagram of a diagnostics system 100 for rapid industrial network troubleshooting for an industrial automation system in accordance with an exemplary embodiment of the present invention. As illustrated in FIG. 2, a communication network 130 interfaces with the user interface device 105 and the automation component 110, and is adapted to transmit data. According to an exemplary embodiment, communication network 130 is an industrial network. The automation component 110 and optional further automation components such as for example sensors, actuators and control devices, of an automation system are interconnected via the industrial network 130 for communication purposes. The automation component 110 and further automation components can be connected wirelessly and/or wired within the industrial network 130. Industrial networks used in an industrial environment include protocols that provide determinism and real-time control. For example, industrial Ethernet (IE) is the use of Ethernet in an industrial environment with protocols that provide determinism and real-time control. According to an exemplary embodiment, the industrial network 130 operates according to PROFINET protocol. But many other protocols for Industrial Ethernet (IE) may be used, for example EtherCAT, EtherNet/IP, POWERLINK, etc.

In an alternative embodiment, the communication network 130 may not be an industrial network, but a network such as for example the Internet or local area networks, or many other network environments that are accessible via an air interface, e.g. Wi-Fi.

The identification tag 115 of the automation component 110 comprises data for identifying the automation component 110. Such data include for example a network address, such as an IP address or a MAC address of the automation component 110.

As noted before, the user interface device 105 comprises a computer program with executable instructions. The computer program includes instructions to read the identification tag 115, and to interpret and/or decode the information embedded in the QR code of the automation component 110. The computer program of the user interface device 105 further comprises instructions to establish communication with the automation component 110 based on data of the identification tag 115 via the communication network 130. The user interface device 105 queries the automation component 110 via the industrial network 130 using the network capability of the user interface device 105. For example, the user interface device 105 uses a wireless network connection to communicate with the automation component 110 over the industrial network 130.

In an alternative embodiment, the identification tag 115 of the automation component 110 may comprise a radio frequency identification (RFID) tag using RFID technology, wherein the user interface device 105 is configured to read and interpret an RFID tag of the automation component 110. In another alternative embodiment, an identification of the automation component 110 may be provided using Bluetooth technology. In this case, the automation component 110 and the user interface device 105 communicate wirelessly via Bluetooth technology and exchange data. In particular, the automation component 105 transmits identification data, such as a network address, of the automation component 105 via Bluetooth technology to the user interface device 105.

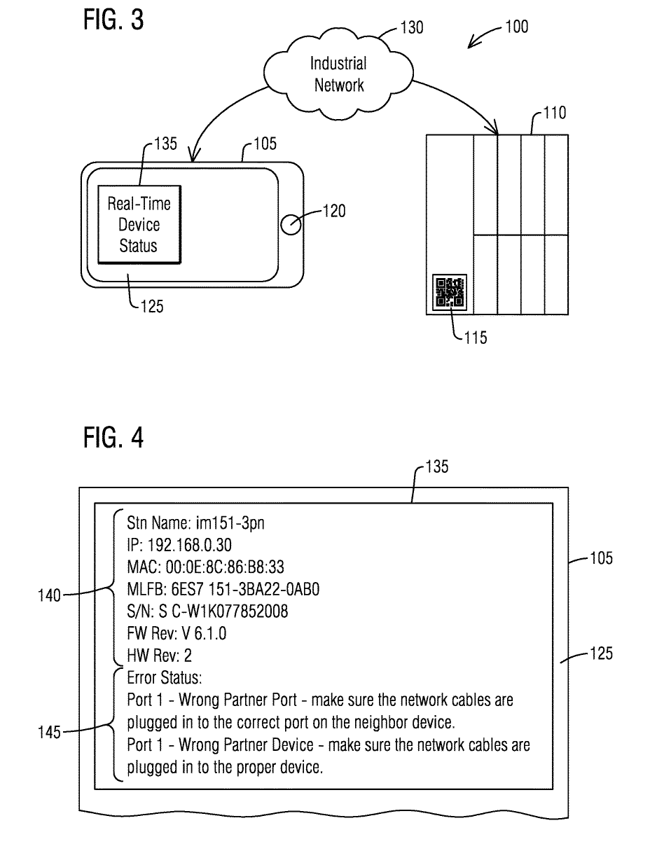

FIG. 3 illustrates a third schematic diagram of a diagnostics system 100 for rapid industrial network troubleshooting for an industrial automation system in accordance with an exemplary embodiment of the present invention.

The user interface device 105 is configured to decode information of the automation component 110 embedded in the identification tag 115, and to establish communication with the automation component 110 over the industrial network 130. The user interface device 105 queries the automation component 110 for diagnostics and/or connection data of the automation component 110 after a communication link has been established with the automation component 110. In an exemplary embodiment, the user interface device 105 retrieves connection data and/or diagnostics data of the automation component 110 via a PROFINET query.

Connection data and/or information can comprise for example data relating to the automation component 110, such as for example network address (IP address, MAC address), name of the component (for example interface module, input/output module), etc. Diagnostics data can comprise for example data relating to an error or fault of the automation component 110. After receiving the connection data and/or diagnostics data from the automation component 110, the user interface device 105 analyzes or parses a response of the automation component 110 to the query and displays the information and/or data of the automation component 110 on the display or screen 125 to the end user or operator of the user interface device 105 in real-time.

FIG. 4 illustrates a graphical representation of a screenshot 135 of a user interface device 105 in accordance with an exemplary embodiment of the present invention. The screenshot 135 of the user interface device 105 shows information retrieved from the automation component 110. The information and/or data displayed on the display or screen 125 of the user interface device 105 includes connection data 140 and diagnostics data 145. It should be noted that the information/data retrieved from the automation component 110 can only be diagnostics data 145, or can comprise additional data such as for example suggested solutions to the diagnosed error or fault as illustrated in FIG. 4. Furthermore, additional data retrieved from the automation component 110 may include real-time process signals or may comprise many other data retrievable from the automation component 110.

The diagnostics data 145 relate to an error or fault of the automation component 110 and are displayed under the heading “Error Status”. In the example of FIG. 4, the diagnostics data 145 include as follows:

“Error Status:
Port 1—Wrong Partner Port—make sure the network cables are plugged in to the correct port on the neighbor device.
Port 1—Wrong Partner Device—make sure the network cables are plugged in to the proper devices.”

In the example of FIG. 4, the connection data 140 include the following for the specific automation component 110:

| | |
|---|---|
| “Stn Name: im151-3pn” = | station name of the device, |
| | wherein “im151-3pn” |
| | relates to an interface module; |
| “IP: 192.168.0.30” = | IP address; |
| “MAC: 00:0E:8C:86:B8:33” = | MAC address; |
| “MLFB: 6ES7 151-3BA22-0AB0” = | machine readable product |
| | designation; |
| “S\N: S C-W1K077852008” = | serial number; |
| “FW Rev: V 6.1.0” = | firmware revision; |
| “HW Rev: 2” = | hardware revision. |

It should be noted that the connection data 140 can comprise more or less data as illustrated in FIG. 4 depending on for example a configuration of the query provided to the automation component 110 by the user interface device 105. Further, the diagnostics data 145 as provided in FIG. 4 are only exemplary. The diagnostics data 145 relate to the current condition and status of the automation component 110, specifically to a fault or error of the automation component 110, wherein a corresponding error status relating to the fault or error is displayed. If the automation component 110 is operating properly without faults or errors, the diagnostics data 145, when retrieved and displayed on the user interface device 105, may include data which may read for example “Error Status: none” or “Error Status: 0” indicating that the automation component 110 is operating without errors.

After receiving the diagnostics data 145 by the end user or operator displayed on the display or screen 125 of the user interface device 105, the automation component 110 can be serviced or repaired accordingly in a very timely manner because the fault/error was diagnosed locally. Further, it should be noted that that a resolution of the error may be verified in real-time by the user interface device 105. For example, the user interface device 105 can be configured such that the error “Port 1—Wrong Partner Device” described above will disappear from the display 125 of the user interface device 105 as soon as connectivity to the corresponding partner device (automation component 110) is re-established.

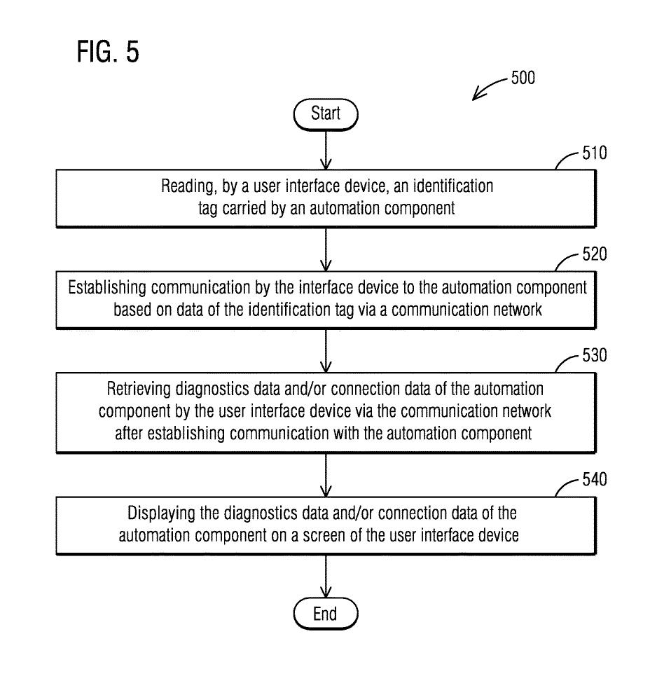

FIG. 5 illustrates a flow chart of a diagnostics method 500 for rapid industrial network troubleshooting for an industrial automation system in accordance with an exemplary embodiment of the present invention. The diagnostics method 500 provided herewith refers to the components and elements as described before with reference to FIGS. 1-4. The diagnostics method 500 comprises steps 510, 520, 530 and 540. Step 510 comprises reading, by the user interface device 105, an identification tag 115 carried by the automation component 110. Step 520 comprises establishing communication by the interface device 105 to the automation component 110 based on data of the identification tag 115 via a communication network 130. In step 530, diagnostics data 145 and/or connection data 140 of the automation component 110 are retrieved by the user interface device 105 via the communication network 130, after communication with the automation component 110 has been established. Then, the diagnostics data 145 and/or connection data 140 of the automation component 110 are displayed on the screen 125 of the user interface device 105 (step 540). It should be appreciated that the described method 500 can comprise more steps, or some steps can be repeated multiple times, or some steps are optional. For example, the user interface device 105 may have stored the data of the identification tag 115 of a specific automation component 110 because of a prior established connection. Therefore, when establishing connection again to the automation component 115, step 510 may not need to be executed, but the user interface device 105 can directly establish connection without reading the identification tag 115. In another example, step 530 may be repeated multiple times because the diagnostics data 145 may change due to different errors or due to a resolution of a previous error or errors while performing the diagnostics method 500.

Summarizing in an exemplary embodiment, the diagnostics system 100 comprises a user interface device 105 configured as a common smart phone including a digital camera, storage capability and wireless capability. Furthermore, the mobile smart phone comprises a computer program with executable instructions. The computer program can be downloaded to the smart phone as a mobile application, also known as an “app” from a mobile app store. In this exemplary embodiment, the automation component 110 is configured as a PLC comprising a QR code as an identification tag 115 attached to the PLC. The network address of the PLC is embedded in the QR code. The industrial network 130 is configured comprising PROFINET protocol. The common smart phone is used to read the QR code via a digital camera of the smart phone and to decode the network address of the PLC. Then, the smart phone establishes connection and queries the PLC via PROFINET protocol over its wireless network connection.

The described diagnostics system 100 and method 500 uses a standard smart device for both hardware and software to display information about network components, in particular automation components of an automation system. Thereby, an inexpensive and easy solution for a diagnostics system is provided since standard smart devices are very common and used by a large population. Thus, the provided system and method 100 and 500 decreases end customer cost by implementing the described features using entirely commercial, off-the-shelf components and software.

Fusing real-world views of network components with real-time status and diagnostic information presents a different solution compared to known technologies and methods. Known technologies have utilized propriety hardware coupled with commercial operating systems and custom applications. Specifically, the provided diagnostics system 100 and method 500 rely on optical asset recognition. Fusing the optical asset recognition with a portable application to access diagnostic information provides a faster, more efficient way for end users and operators of the automation components and automation system to access the information they need to maintain their production facilities. Faults of network components can now be diagnosed locally in an easy and inexpensive manner. Thus, customer efficiency is increased by decreasing the effort required to coordinate responses to unscheduled maintenance on the factory floor by shortening the time to access diagnostic information from several minutes to several seconds.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

1. A diagnostics system for rapid industrial network troubleshooting for an automation system comprising:
a user interface device comprising a memory device storing a computer program with executable instructions;
an automation component comprising an identification tag; and
a communication network interfacing with the user interface device and the automation component, and adapted to transmit data,
wherein the computer program of the user interface device comprises instructions to establish communication with the automation component based on data of the identification tag via the communication network, and
wherein the computer program of the user interface device comprises instructions to retrieve diagnostics data of the automation component via the communication network after establishing communication with the automation component.

2. The diagnostics system of claim 1, wherein the computer program of the user interface device comprises instructions to read the identification tag of the automation component and to decode a network address embedded in the identification tag of the automation component.

3. The diagnostics system of claim 1, wherein the identification tag comprises a QR code or a barcode.

4. The diagnostics system of claim 1, wherein the data of the identification tag comprises a network address of the automation component.

5. The diagnostics system of claim 1, wherein the communication network is an industrial network comprising one or more industrial Ethernet protocols.

6. The diagnostics system of claim 5, wherein the communication network comprises PROFINET protocol.

7. The diagnostics system of claim 1, wherein the user interface device is selected from the group consisting of a tablet, a smart phone, and a handheld computing device.

8. A computer program product embodied in a non-transitory computer-readable medium comprising:
instructions to read an identification tag carried by an automation component,
instructions to establish communication to the automation component based on data of the identification tag via a communication network; and
instructions to retrieve diagnostics data of the automation component via the communication network after establishing communication with the automation component.

9. The computer program product of claim 8, wherein the identification tag comprises a QR code or barcode.

10. The computer program product of claim 8, further comprising:
instructions to display the diagnostics data of the automation component on a screen of a user interface device.

11. The computer program product of claim 8, further comprising:
instructions to decode a network address embedded in the identification tag of the automation component.

12. The computer program product of claim 11, wherein the network address comprises an IP address or MAC address of the automation component.

13. The computer program product of claim 8, wherein the non-transitory computer readable medium is configured as a storage device of a user interface device.

14. The computer program product of claim 8, wherein the communication network comprises PROFINET protocol.

15. A diagnostics method for rapid industrial network troubleshooting for an automation system comprising:
reading, by a user interface device, an identification tag carried by an automation component,
establishing communication by the interface device to the automation component based on data of the identification tag via a communication network; and
retrieving diagnostics data of the automation component by the user interface device via the communication network after establishing communication with the automation component.

16. The diagnostics method of claim 15, further comprising:
displaying the diagnostics data of the automation component on a screen of the user interface device.

17. The diagnostics method of claim 15, further comprising:
retrieving connection data of the automation component by the user interface device via the communication network, the connection data comprising a network address of the automation component.

18. The diagnostics method of claim 15, wherein the identification tag comprises a network address of the automation component embedded in a QR code.

19. The diagnostics method of claim 15, wherein the user interface device is selected from the group consisting of a tablet, a smart phone, and a mobile computing device.

20. The diagnostics method of claim 15, wherein the automation component comprises at least one programmable logic controller (PLC).
